(19) United States
(12) Patent Application Publication
(10) Pub. No.: US 2026/0059349 A1
(43) Pub. Date: Feb. 26, 2026

(54) NETWORK OUTAGE COVERAGE OPTIMIZER

(71) Applicant: T-MOBILE INNOVATIONS LLC, Overland Park, KS (US)

(72) Inventor: Krunal Mansukhlal MODASIYA, Aldie, VA (US)

(21) Appl. No.: 18/814,105

(22) Filed: Aug. 23, 2024

(51) Int. Cl. H04W 24/02; H04W 16/28

(52) U.S. Cl. CPC H04W 24/02; H04W 16/28

(57) ABSTRACT

At a high level, the technology disclosed herein relates to network outage coverage optimization. For example, in embodiments, an access point or server associated with the access point can determine that a neighboring access point has a network outage for at least a portion of a coverage area for the neighboring access point. Based on determining that the neighboring access point has the network outage, a tilt angle of one or more antennas or antenna arrays of the access point may be adjusted to provide coverage for at least the portion of the coverage area for the neighboring access point.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for network outage optimization and coverage retention. In embodiments, an access point or server associated with the access point can determine that a neighboring access point has a network outage for at least a portion of a coverage area for the neighboring access point. Based on determining that the neighboring access point has the network outage, a tilt angle of one or more antennas or antenna arrays of the access point may be adjusted to provide coverage for at least the portion of the coverage area for the neighboring access point.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for network coverage optimization during site outages, in accordance with embodiments herein;

FIG. 2 depicts an example flowchart for implementing network coverage optimization during a site outage, in accordance with embodiments herein;

FIG. 3 depicts an example flowchart for maintaining network coverage optimization without a site outage, in accordance with embodiments herein;

FIG. 4 depicts another example flowchart for implementing the network coverage optimization during a site outage, in accordance with embodiments herein;

FIG. 5 depicts example embodiments of network coverage provided by a cell site during a normal scenario and an outage scenario, in accordance with embodiments herein;

FIG. 6 depicts another example flowchart for network coverage optimization during a site outage, in accordance with embodiments herein; and

FIG. 7 depicts an example network outage optimizer client associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, cell sites and other access points providing access to the network may experience outage scenarios (e.g., a utility power outage of a main power supply, a backup power supply failing, radio transceiver failure, antenna failure, baseband unit failure, other hardware malfunctioning, backhaul link failure, software misconfiguration, natural disaster or severe weather, etc.). For example, a network with multiple technologies (e.g., new radio, Long-Term Evolution, Global System for Mobile Communications, etc.) and multiple layers (e.g., 600 MHz, 700 MHz, 1900 MHz, 2100 MHz, 2500 MHz, 3500 MHz, etc.) may having various complexities may encounter one or more outage scenarios for various reasons based on these technologies and layers.

During a site outage, user devices may lose telecommunication coverage, have sudden call drops or handover issues (e.g., based on having no coverage footprint from serving site). For instance, network outages may result in user devices having no access to the network (e.g., until a crew member or a technician resolves the issues at a physical tower of the serving cell site). Cell site outages can cause loss of signals (e.g., lost data sessions) and dead zones (e.g., areas where no signal is available for messaging, calls, mobile data usage, etc.). In addition, video streaming or file downloads can be interrupted and can fail to resume due to the length of an outage. Furthermore, mobile devices moving to a different coverage area may experience handover issues, and different cell sites may not be optimized to handle additional loads, which can result in uncoordinated coverage and interference issues with network coverage and connectivity.

Embodiments of the technology discussed herein provide various improvements to the challenges discussed above. For example, the technology described herein can improve network coverage retention during network outages from one or more access points that are experiencing a network outage (e.g., an outage based on a utility power outage of a main power supply, a backup power supply failing, radio transceiver failure, antenna failure, baseband unit failure, other hardware malfunctioning, backhaul link failure, software misconfiguration, natural disaster or severe weather, etc.). As a non-limiting example, an access point (e.g., a gNodeB) may leverage the X2 interface with a neighboring access point to detect a network outage of the neighboring access point. Upon detection of a network outage of the neighboring access point, the access point may trigger one or more of its transmitters to adjust its antenna configurations (e.g., using e-tilt features (e.g., an adjustment of an antenna radiation pattern by electronically altering the phase of the signal being fed to the antenna elements to change a vertical angle at which the antenna radiates a signal without physically moving the antenna itself) to provide additional coverage to a missing footprint of the neighboring access point experiencing the outage.

In an embodiment, a system for network outage coverage optimization is provided. The system may comprise one or more processors and computer memory storing computer-usable instructions that, when executed by the one or more processors, cause the one or more processors to perform operations. The operations may comprise determining that a neighboring cell site has a network outage. The operations may also comprise identifying a network coverage area associated with the network outage. The operations may also comprise adjusting a tilt angle of at least one antenna based on the network coverage area. Based on adjusting the tilt angle, a frequency band may be transmitted to at least a portion of the network coverage area associated with the network outage of the neighboring cell site.

In another embodiment, a method is provided for network outage coverage optimization. For example, the method may comprise receiving an indication that a neighboring cell site has a network outage. The method may also comprise determining parameters of a network coverage area associated with the network outage. Based on the parameters of the network coverage area, a tilt angle of at least one antenna may be adjusted. Based on adjusting the tilt angle, a frequency band may be transmitted to at least a portion of the network coverage area associated with the network outage of the neighboring cell site.

In another example embodiment, one or more computer storage media having computer-executable instructions embodied thereon, that when executed by at least one processor, cause the at least one processor to perform a method. The method may comprise determining that a neighboring access point, of a first access point, has a network outage. Based on determining that the neighboring access point has the network outage, the media may cause a tilt angle of at least one antenna of the first access point to be adjusted. Based on causing the tilt angle to be adjusted, the media may cause a frequency band from the first access point to be transmitted to at least a portion of a network coverage area associated with the network outage of the neighboring access point.

### Example Operating Environments

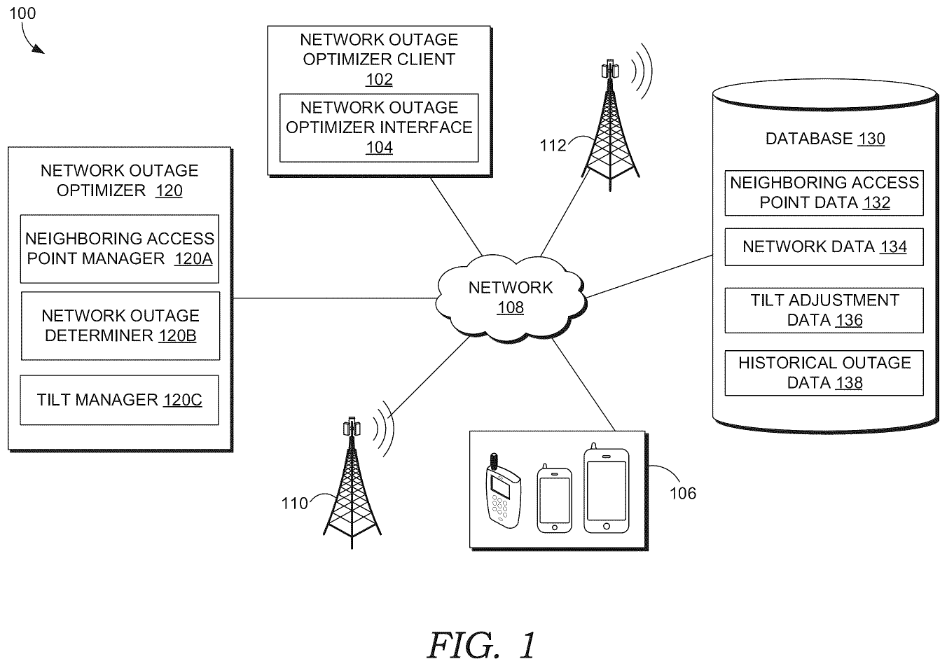

Turning now to FIG. 1, example operating environment 100 is illustrated in accordance with one or more embodiments disclosed herein. At a high level, the example operating environment 100 comprises network outage optimizer client 102 including network outage optimizer interface 104; user devices 106; network 108; cell site 110 and neighboring cell site 112; network outage optimizer 120 including neighboring access point manager 120A, network outage determiner 120B, and tilt manager 120C; and database 130 including neighboring access point data 132, network data 134, tilt adjustment data 136, and historical outage data 138.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional network outage optimizer clients or other configurations of the database 130 (e.g., database 130 may be a distributed computing environment encompassing multiple computing devices for storing one or more of the neighboring access point data 132, network data 134, tilt adjustment data 136, and historical outage data 138).

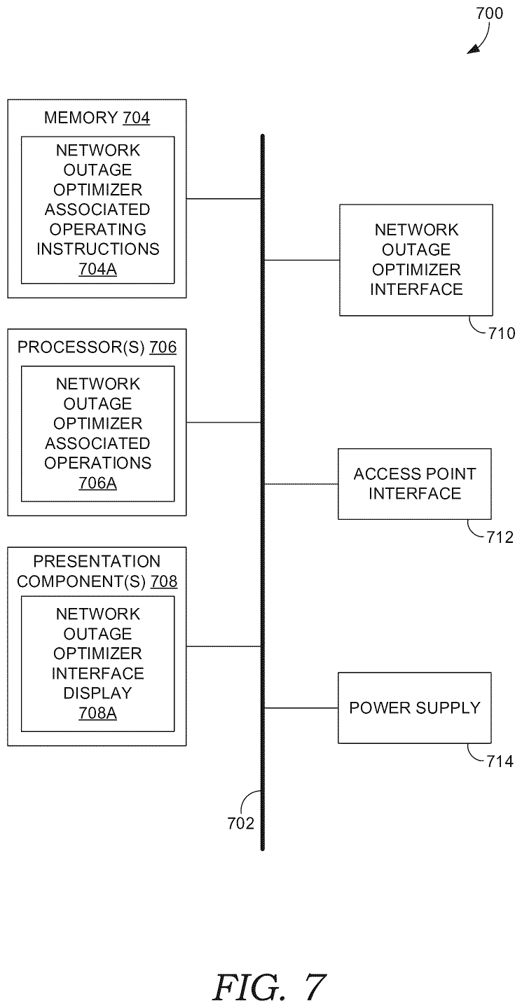

Network outage optimizer client 102 may be a device that has the capability of communicating (e.g., transmitting or receiving one or more signals to or from) with one or more of the cell site 110, neighboring cell site 112, network outage optimizer 120, and database 130 over the network 108. In some embodiments, the network outage optimizer client 102 or one or more of the user devices 106 may be a “user device,” “computing device,” “mobile device,” “client,” “user equipment (UE),” or “wireless communication device.” In some embodiments, the network outage optimizer client 102 may be a server. The network outage optimizer client 102 or one or more of the user devices 106, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating over the network 108. In some embodiments, the network outage optimizer client 102 may be example network outage optimizer client 700 described herein with respect to FIG. 7.

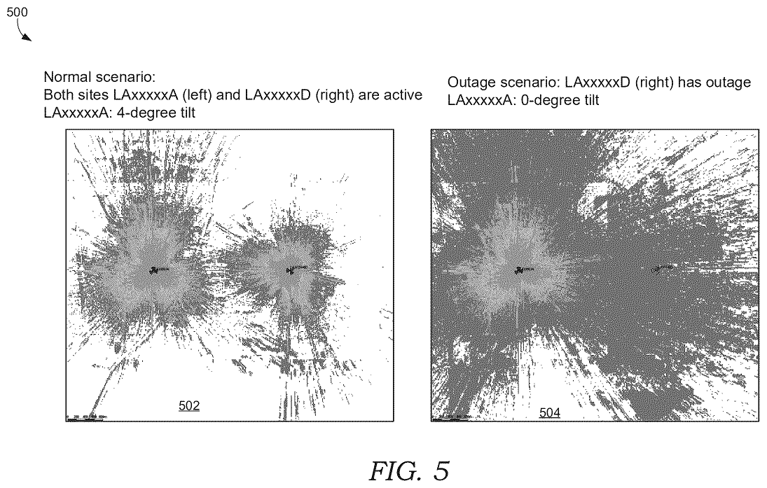

The network outage optimizer client 102 may be, in an embodiment, capable of providing for display, via the network outage optimizer interface 104 (e.g., via presentation component(s) 708 of FIG. 7), one or more data items stored within database 130 (e.g., the neighboring access point data 132, network data 134, tilt adjustment data 136, and historical outage data 138), example network coverage visualizations of FIG. 5 (or a portion thereof), coverage area parameters of a neighboring access point (e.g., coverage area coordinates, coverage area radius, a cell sector direction, cell sector coordinates), indications provided from a neighboring access point (e.g., over a backhaul, over an X2 interface, over an Xn interface, etc.), antenna tilt angle adjustments and readjustments, etc., or one or more combinations thereof.

In embodiments, the network outage optimizer interface 104 may be one or more presentation component(s) 708 of FIG. 7. In embodiments, the network outage optimizer interface 104 may display image data, text data, extended reality data, other types of data, or one or more combinations thereof, based on one or more operations of the network outage optimizer 120 (e.g., operations associated with the neighboring access point manager 120A, network outage determiner 120B, and tilt manager 120C, etc.).

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., network outage optimizer client 102, cell site 110, neighboring cell site 112, network outage optimizer 120, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof.

In embodiments, the cell site 110 may be a station that communicates with the user devices 106, the network outage optimizer 120, the network outage optimizer client 102, the neighboring cell site 112, etc. In embodiments, the cell site 110 may be a macro cell, a micro cell, a picocell, femtocell, small cell, microcell, a distributed antenna system (e.g., a network of distributed antennas connected to a central source), a remote radio head, another type of access point, etc., or one or more combinations thereof. In some embodiments, the cell site 110 may include an evolved node B (eNodeB) and the neighboring cell site 112 may include a next generation node B (gNodeB). For instance, the cell site 110 may transmit frequency bands from the eNodeB to a coverage area previously provided by the neighboring cell site 112 based on the network outage optimizer 120 determining that the neighboring cell site 112 has a network outage, and based on the gNodeB of the neighboring cell site 112 not providing the coverage area due to the network outage. As another example with respect to a different embodiment, the cell site 110 may transmit frequency bands from its gNodeB to a coverage area previously provided by the neighboring cell site 112 based on the network outage optimizer 120 determining that the neighboring cell site 112 has a network outage, and based on the eNodeB of the neighboring cell site 112 not providing the coverage area due to the network outage. In other example embodiments, the cell site 110 and the neighboring cell site 112 may each have an eNodeB or may each have a gNodeB.

In embodiments, data stored within the database 130 may be stored based on cell site 110 communications and based on neighboring cell site 112 communications. For example, the neighboring access point data 132 may include coverage area information that the neighboring cell site 112 provides, such as a number of sectors, sector coordinates, coverage area coordinates, coverage area maps, footprints of the neighboring cell site 112, etc., or one or more combinations thereof. As another example, the network data 134 may include network data 134 associated with one or more of the cell site 110 and the neighboring cell site 112. For instance, the network data 134 may include Reference Signal Received Power (RSRP) reported by user devices communicating with the neighboring cell site 112, Reference Signal Received Quality (RSRQ) reported by user devices communicating with the neighboring cell site 112, Received Signal Strength Indicator (RSSI) reported by user devices communicating with the neighboring cell site 112, Signal to Interference plus Noise Ratio (SINR) associated with the coverage area provided by the neighboring cell site 112, RSRP reported by user devices 106 communicating with the cell site 110, etc., or one or more combinations thereof.

Tilt adjustment data 136 (e.g., for the cell site 110) may include electrical tilt settings, angles for antenna radiation patterns, mechanical tilt settings, coverage area changes based on tilt adjustments (e.g., to antennas of the cell site 110 and the neighboring cell site 112), changes to RSRP, RSRQ, SINR, etc., based on tilt adjustments, handover parameters associated with tilt adjustments, interference values associated with tilt adjustments, etc., or one or more combinations thereof. Historical outage data 138 (e.g., for neighboring cell site 112 or another cell site that neighbors the cell site 110) may include historical outage causes (e.g., weather, utility power outage of a main power supply, a particular radio transceiver, a particular antenna array, baseband unit, backhaul link, etc.) and historical coverage areas affected.

In embodiments, the network outage optimizer 120 may comprise computing devices (e.g., one or more servers). In some embodiments, the network outage optimizer 120 may be a single server, a distributed computing environment encompassing multiple computing devices located at the same physical geographical location or at different physical geographical locations, another type of server environment, etc. In embodiments, the network outage optimizer 120 may comprise one or more processors, one or more electronics devices, one or more hardware devices, one or more electronics components, one or more logical circuits, one or more memories, one or more software codes, one or more firmware codes, etc., or one or more combinations thereof.

The network outage optimizer 120 may access the database 130 to execute tasks (e.g., associated with the neighboring access point manager 120A, network outage determiner 120B, tilt manager 120C, etc.). For example, a user—via the network outage optimizer client 102 (e.g., via the network outage optimizer interface 104)—may transmit a request to communicate with the network outage optimizer 120. The network outage optimizer 120 may receive, retrieve, analyze, and store the neighboring access point data 132, network data 134, tilt adjustment data 136, and historical outage data 138 at/from the database 130.

In some embodiments, the network outage optimizer 120 may utilize neighboring access point manager 120A to define an active set of neighbors for the cell site 110 (e.g., the active set of neighbors including neighboring cell site 112). By way of example, the neighboring access point manager 120A can define the neighboring cell site 112 as the active neighbor for the cell site 110, such that cell site 110 will apply antenna tilt adjustments (e.g., reconfigure an electrical tilt) for an antenna or antenna array of the cell site 110 so that the cell site 110 can provide the missing coverage of a missing footprint for the neighboring cell site 112 upon an outage associated with the neighboring cell site 112. In embodiments, the neighboring cell site 112 may not have to reconfigure any operational parameters based on the neighboring access point manager 120A defining the neighboring cell site 112 as the active neighbor for the cell site 110. In some embodiments, the neighboring access point manager 120A may define a plurality of neighboring cell sites for the cell site 110 so that the cell site 110 can provide the missing coverage of a missing footprint for each of the neighboring cell sites upon a neighboring cell site outage.

In embodiments, the neighboring access point manager 120A can generate a network outage neighboring access point list (e.g., to store in the database as neighboring access point data 132) that can be updated (e.g., by way of adding or removing an access point from the network outage neighboring access point list) or otherwise managed by the neighboring access point manager 120A. In embodiments, the neighboring access point manager 120A can generate the network outage neighboring access point list by including a physical cell identity for each access point on the list, frequency identifiers for coverage areas provided by the neighboring access points, cell identities and location area codes associated with routing or handover for each of the neighboring access points, a broadcast control channel for a neighboring access point, a physical broadcast channel for a neighboring access point, a cell type (e.g., GSM, UMTS, LTE, 5G NR) for each neighboring access point, etc., or one or more combinations thereof.

In some embodiments, the neighboring access point manager 120A can generate the network outage neighboring access point list by identifying access points within a threshold distance from the cell site 110, by identifying access points having an overlapping coverage area with the cell site 110, access points associated with handovers by the cell site 110, etc., or one or more combinations thereof. In some embodiments, the neighboring access point manager 120A can store one or more network outage neighboring access point lists at a base transceiver station, a base station controller, an eNodeB configuration file, a self-organizing network, a network management system, a centralized configuration management system, etc., associated with the cell site 110. In embodiments, the network outage determiner 120B can determine that one or more of the neighboring access points on the network outage neighboring access point list has a network outage.

By way of example, the network outage determiner 120B can use the network outage neighboring access point list to determine that the neighboring cell site 112 has a network outage, and to identify a network coverage area associated with the network outage of the neighboring cell site 112. In embodiments, the network coverage area can be determined based on coverage area parameters of the neighboring cell site 112 (e.g., coverage area coordinates, coverage area radius, a cell sector direction, cell sector coordinates). In some embodiments, the network coverage area can be determined based on the frequency identifiers of the neighboring cell site 112 within the network outage neighboring access point list, a cell identity and location area codes within the network outage neighboring access point list, a broadcast control channel for the neighboring cell site 112 within the network outage neighboring access point list, a physical broadcast channel for the neighboring cell site 112 within the network outage neighboring access point list, a cell type of the neighboring cell site 112 within the network outage neighboring access point list, etc., or one or more combinations thereof.

In some embodiments, the network coverage area associated with an outage of the neighboring cell site 112 can be determined based on neighboring access point data 132 or network data 134 of the neighboring cell site 112. For example, the network coverage area can be determined based on a sector number or sector coordinates reported by the neighboring cell site 112, a coverage area map of a sector provided by the neighboring cell site 112, a coverage footprint of the neighboring cell site 112, RSRP reported by user devices communicating with the neighboring cell site 112, RSRQ reported by user devices communicating with the neighboring cell site 112, RSSI reported by user devices communicating with the neighboring cell site 112, etc., or one or more combinations thereof.

Based on the network outage determiner 120B determining that the neighboring cell site 112 has the network outage, the tilt manager 120C may adjust a tilt angle of at least one antenna of the cell site 110 for transmitting a frequency band to at least a portion of the network coverage area associated with the network outage of the neighboring cell site 112. In embodiments, the tilt angle can be adjusted based on one or more network coverage parameters of the network coverage area associated with the network outage of the neighboring cell site 112. In embodiments, the tilt manager 120C may adjust a tilt angle based on tilt adjustment data 136 (e.g., based on a current electrical tilt setting of the cell site 110, based on a current antenna radiation pattern of the cell site 110) or based on historical outage data 138 associated with the neighboring cell site 112. In some embodiments, the tilt manager 120C may implement a particular electronic tilt adjustment for an antenna or antenna array of the cell site 110 based on an inter-site distance and frequency band of a transmitter associated with the antenna or antenna array of the cell site 110 and an antenna or antenna array of the neighboring cell site 112 associated with the network outage. For example, the inter-site distance may correspond to a transmitter failure of the neighboring cell site 112 and the antenna array of the cell site 110 providing coverage based on the transmitter failure. As another example, the antenna array of the cell site 110 may transmit a frequency band that the failed transmitter of the neighboring cell site 112 was providing prior to the outage. In embodiments, the tilt manager 120C may adjust an electrical tilt angle automatically based on a defined parameter value, and may automatically readjust the electrical tilt angle to the previous angle upon restoration of the outage associated with the neighboring cell site 112.

The tilt manager 120C may also cause a frequency band from an antenna of the cell site 110 to be transmitted to at least a portion of a network coverage area associated with the network outage of the neighboring cell site 112 based on adjusting the tilt angle of the antenna. For example, the tilt manager 120C may cause frequency bands from antennas of the cell site 110 to be transmitted to cover a footprint that the neighboring cell site 112 provided prior to the network outage. In embodiments, the tilt manager 120C may determine that the neighboring cell site no longer has the network outage, and may readjust the tilt angle of the cell site 110 antenna by applying an electrical down tilt to the antenna upon the network outage being restored.

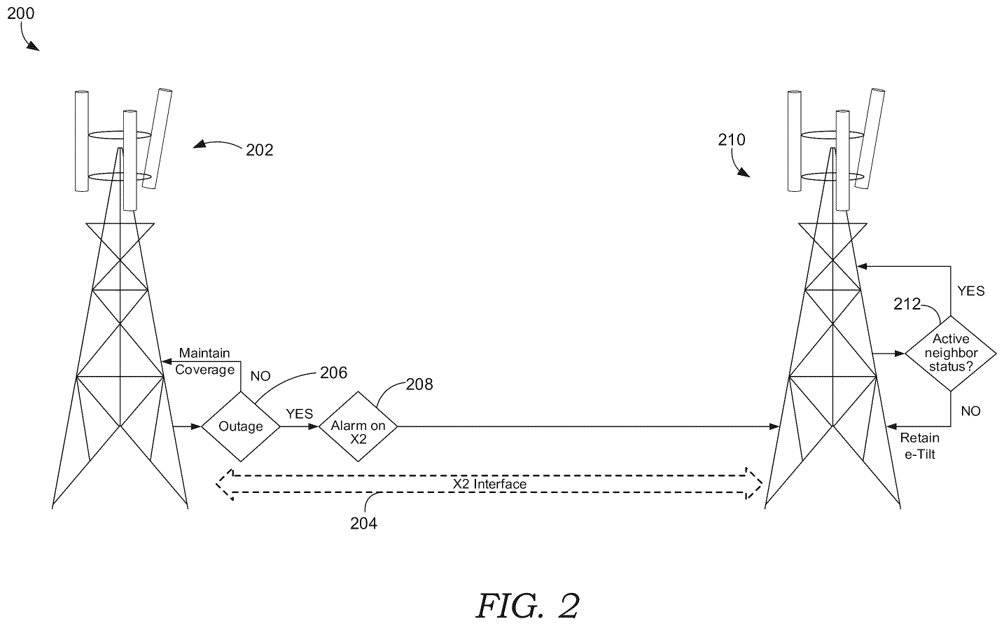

FIG. 2 illustrates an example flowchart 200 for implementing network coverage optimization during a site outage. Example flowchart 200 includes neighboring cell site 202 and a first cell site 210 that may communicate with each other over the X2 interface 204. In embodiments, upon determination of a network outage 206 (e.g., by network outage optimizer 120 of FIG. 1) of the neighboring cell site 202, the neighboring cell site 202 may transmit an alarm indication 208 over the X2 interface. Upon the first cell site 210 receiving the alarm indication 208 over the X2 interface, the first cell site 210 may determine that the neighboring cell site 202 has an active neighbor status 212 (e.g., based on a list of neighboring cell sites). Based on the neighboring cell site 202 having the active neighbor status 212, the first cell site 210 may adjust a tilt angle of at least one antenna and may transmit a frequency band to at least a portion of the network coverage area associated with the network outage of the neighboring cell site 202.

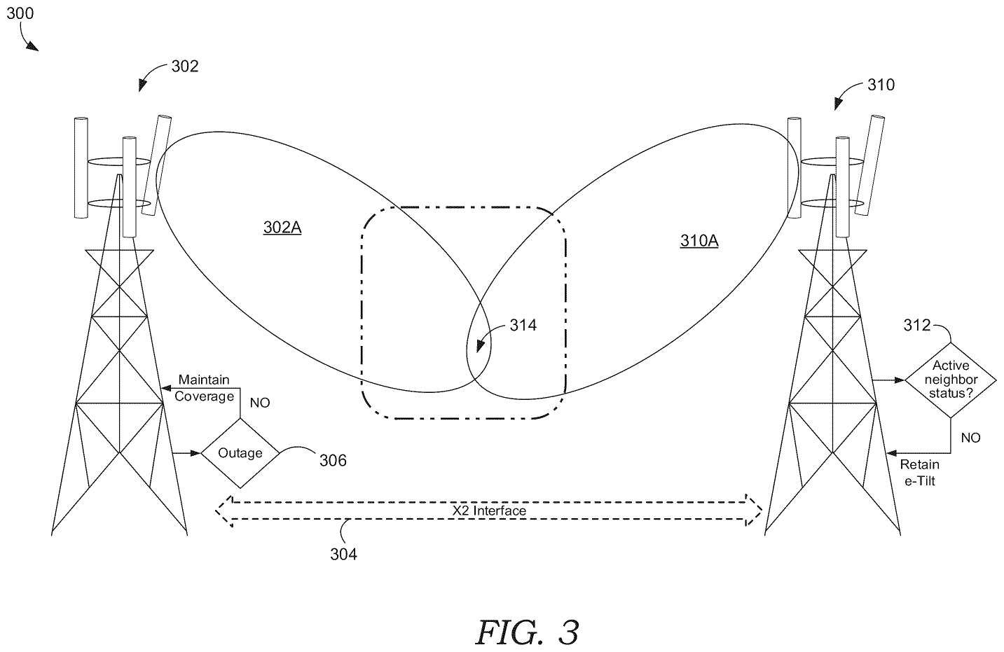

FIG. 3 illustrates an example flowchart 300 for a first cell site 310 maintaining network coverage optimization without the neighboring cell site 302 having a network outage. For example, without the neighboring cell site 302 having the network outage, the neighboring cell site 302 does not transmit an indication alarm to the first cell site 310 over the X2 interface 304. Rather, without network outage 306, the neighboring cell site 302 maintains its coverage (e.g., without implementing electrical tilt adjustments) and does not trigger the first cell site 310 to determine whether indications over the X2 interface have an active neighbor status 312. As depicted in FIG. 3, the frequency band(s) 302A provided by the neighboring cell site 302 and the frequency band(s) 310A provided by the first cell site 310 are transmitted to reduce overlap 314.

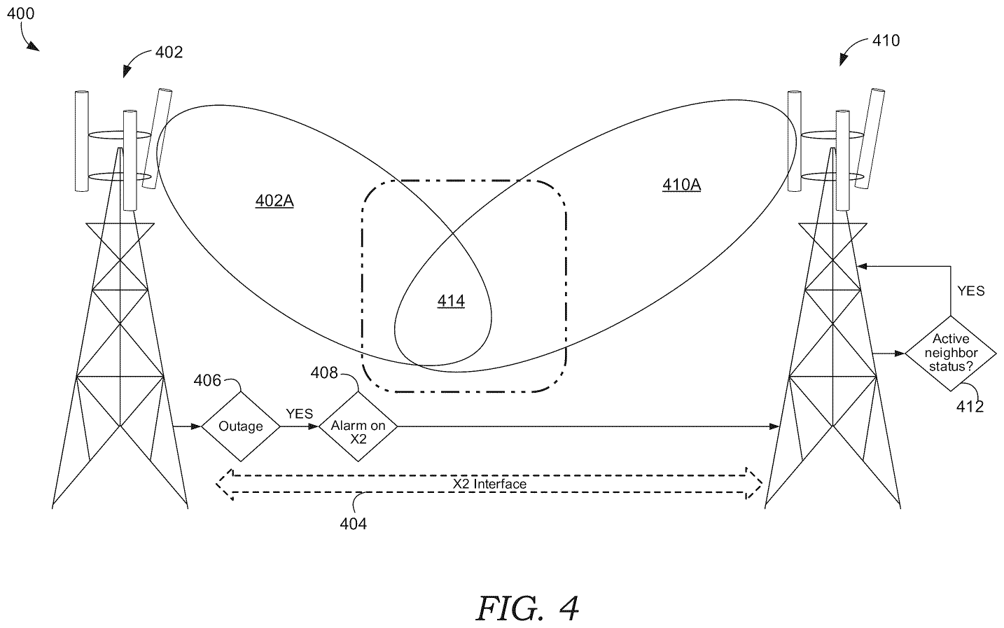

FIG. 4 depicts another example flowchart 400 for implementing the network coverage optimization during a site outage of the neighboring cell site 402. Example flowchart 400 includes neighboring cell site 402 and a first cell site 410 that may communicate with each other over the X2 interface 404. In embodiments, upon determination of a network outage 406 (e.g., by network outage optimizer 120 of FIG. 1) of the neighboring cell site 402, the neighboring cell site 402 may transmit an alarm indication 408 over the X2 interface. Upon the first cell site 410 receiving the alarm indication 408 over the X2 interface, the first cell site 410 may determine that the neighboring cell site 402 has an active neighbor status 412 (e.g., based on a list of neighboring cell sites). Based on the neighboring cell site 402 having the active neighbor status 412, the first cell site 410 may adjust a tilt angle of at least one antenna (e.g., by applying an up tilt) and may transmit a frequency band to at least a portion of the network coverage area associated with the network outage of the neighboring cell site 402. As depicted in FIG. 4, the frequency band(s) 402A that were previously provided by the neighboring cell site 402 prior to the network outage now have overlap 414 with the frequency band(s) 410A provided by the first cell site 410 based on adjusting the antenna tilt angle upon network outage at the neighboring cell site 402. Stated differently, the frequency band(s) 410A from the first cell site 410 is transmitted to at least a portion of a network coverage area associated with the network outage of the neighboring cell site 402.

FIG. 5 depicts example network coverage visualizations 500 that include example embodiments of network coverage provided by a cell site during a normal scenario and an outage scenario. For example, example network coverage visualization 502 illustrates a normal scenario with two neighboring cell sites providing coverage without a network outage, and example network coverage visualization 504 illustrates an outage scenario with one of the neighboring cell sites providing coverage. By way of example, the example network coverage visualization 504 may illustrate an example embodiment associated with example flowchart 400, and the example network coverage visualization 502 may illustrate an example embodiment associated with example flowchart 300.

### Example Flowchart

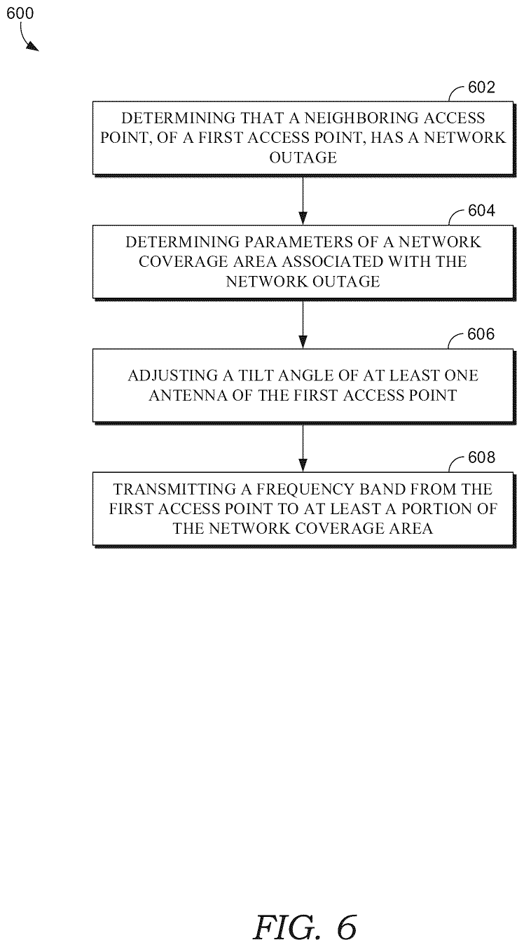

FIG. 6 includes flowchart 600, which begins at step 602 with determining that a neighboring access point, of a first access point, has a network outage. In some embodiments, determining that the neighboring access point has the network outage may be based on receiving an indication (e.g., by the network outage optimizer 120 or the cell site 110 of FIG. 1) over an X2 interface that the neighboring access point has the network outage. In some embodiments, determining that the neighboring access point has the network outage may be based on receiving an indication over an Xn interface that the neighboring cell site has the network outage. In some embodiments, determining that the neighboring cell site has the network outage may be based on receiving an indication over a backhaul that the neighboring cell site has the network outage. In some embodiments, the neighboring cell site may be determined as having the network outage based on a generated list of neighboring cell sites (e.g., a network outage neighboring access point list generated by the neighboring access point manager 120A of FIG. 1). In some embodiments, the network outage determiner 120B of FIG. 1 determines that the neighboring access point has a network outage. In some embodiments, the neighboring access point is a gNodeB and the first access point is an eNodeB.

Step 604 comprises determining parameters of a network coverage area associated with the network outage. In embodiments, the parameters of the network coverage area associated with the outage may be retrieved from a database (e.g., database 130 of FIG. 1). In some embodiments, the parameters of the network coverage area may be determined based on the parameters being received through an indication over an X2 interface, an Xn interface, another type of interface, a backhaul, etc. In embodiments, the parameters of the network coverage area may include coverage area coordinates, coverage area radius, a cell sector direction, cell sector coordinates, a coverage area map, a footprint of the coverage area provided by the neighboring access point, frequency band identifiers, etc., or one or more combinations thereof. In some embodiments, the network outage determiner 120B of FIG. 1. Determines the parameters of the network coverage area.

Step 606 comprises adjusting a tilt angle of at least one antenna of the first access point (e.g., based on determining that the neighboring access point has the network outage and based on determining parameters of a network coverage area associated with the network outage). In embodiments, the tilt angle is adjusted by applying an electrical up tilt. In embodiments, the tilt angle of an antenna array comprising the at least one antenna may be adjusted (e.g., by applying an electrical up tilt). In embodiments, the tilt angle adjustments may be stored as tilt adjustment data 136 of FIG. 1. In some embodiments, adjusting the tilt angle may be determined based on historical outage data associated with the neighboring access point. In embodiments, the tilt angle is adjusted, or caused to be adjusted, by the tilt manager 120C of FIG. 1.

Step 608 comprises transmitting a frequency band (or causing the frequency band to be transmitted) to at least a portion of the network coverage area associated with the network outage of the neighboring cell site, the transmitting based on adjusting the tilt angle. In embodiments, the frequency band may correspond to a frequency band in which the neighboring cell site was providing to the coverage area. In some embodiments, a plurality of different frequency bands, including the frequency band, may be transmitted to at least the portion of the network coverage area. In embodiments, the frequency band is transmitted (or caused to be transmitted) by the tilt manager 120C of FIG. 1. In some embodiments, based on the neighboring access point no longer having the network outage (e.g., based on receiving an indication that the neighboring access point no longer has the network outage), the tilt angle (e.g., of the antenna) may be readjusted (e.g., by applying a down tilt to the antenna).

### Example Network Outage Optimizer Client

Referring now to FIG. 7, a diagram is depicted of an example network outage optimizer client suitable for use in implementations of the present disclosure. In particular, the example network outage optimizer client is shown and designated generally as network outage optimizer client 700. Example network outage optimizer client 700 is but one example of a suitable computing environment and is not intended to suggest any limitation as to the scope of use or functionality of the invention. Neither should network outage optimizer client 700 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 7, network outage optimizer client 700 includes bus 702 that directly or indirectly couples the following devices: memory 704, one or more processors 706, one or more presentation components 708, network outage optimizer interface 710, access point interface 712, and power supply 714. The memory 704 may include network outage optimizer associated operating instructions 704A, which may be executed by the processor(s) 706 to perform network outage optimizer associated operations 706A. The one or more presentation components 708 may include network outage optimizer interface display 708A.

Although the components of FIG. 7 are shown with lines for the sake of clarity, in reality, delineating various components is not so clear, and metaphorically, the lines would more accurately be grey and fuzzy. For example, processors, such as one or more processors 706, have memory. The present disclosure hereof recognizes that such is the nature of the art, and reiterates that FIG. 7 is merely illustrative of an example network outage optimizer client 700 that may be used in connection with one or more implementations of the present disclosure.

In some embodiments, the network outage optimizer client 700 may be a “workstation,” “server,” “laptop,” “handheld device,” “computing device,” etc. In some embodiments, the network outage optimizer client 700 may be network outage optimizer client 102 of FIG. 1.

In some embodiments, bus 702 may represent what may be one or more busses (such as an address bus, data bus, or a combination thereof).

The network outage optimizer client 700 may include a variety of computer-readable media. Computer-readable media may be any available media that may be accessed by network outage optimizer client 700 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 704 includes computer-storage media in the form of volatile and/or nonvolatile memory. Memory 704 may be removable, non-removable, or a combination thereof. Examples of memory 704 may include solid-state memory, hard drives, optical-disc drives, etc., or one or more combinations thereof.

Example network outage optimizer client 700 also includes one or more processors 706 that read data from one or more entities, such as bus 702, memory 704, one or more presentation components 708, network outage optimizer interface 710, access point interface 712, or power supply 714. In embodiments, the network outage optimizer interface 710 may be network outage optimizer interface 104 of FIG. 1. In embodiments, the network outage optimizer client 700 may communicate with database 130 and neighboring cell site 112 of FIG. 1 via the access point interface 712.

Examples of one or more processors 706 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

The processor(s) 706 may perform network outage optimizer associated operations 706A. For example, the network outage optimizer associated operations 706A may include receiving an indication that a neighboring cell site has a network outage, receiving network coverage area parameters or a network coverage area map associated with the network outage, receiving tilt angle adjustments made to an antenna array to provide coverage to an area for a neighboring base station, receiving frequency band being provided to the area, etc. In embodiments, the network outage optimizer associated operations 706A may include causing one or more of the steps (or portions thereof) discussed above with respect to FIG. 6.

One or more presentation components 708 may present (e.g., to a person or other device) various data instances (e.g., based on operations of the network outage optimizer 120 of FIG. 1). Examples of the one or more presentation components 708 may include a display device, speaker, printing component, vibrating component, etc. In some embodiments, the one or more presentation components 708 may present data received via the network outage optimizer interface 710 or the access point interface 712. In some embodiments, the network outage optimizer interface display 708A may display example network coverage visualizations of FIG. 5 (or a portion thereof).

In embodiments, the network outage optimizer client 700 facilitates communication with a wireless telecommunications network (e.g., via a radio). Illustrative wireless telecommunications technologies may include CDMA, GPRS, TDMA, GSM, and the like. The network outage optimizer client 700 might additionally or alternatively facilitate other types of wireless communications including Wi-Fi, WiMAX, LTE, or other VOIP communications. As can be appreciated, in various embodiments, the network outage optimizer client 700 may be configured to support multiple technologies and/or multiple radios may be utilized to support multiple technologies.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for network outage coverage optimization, the system comprising:
one or more processors; and
computer memory storing computer-usable instructions that, when executed by the one or more processors, cause the one or more processors to perform operations comprising:
determining that a neighboring cell site has a network outage;
identifying a network coverage area associated with the network outage;
based on the network coverage area, adjusting a tilt angle of at least one antenna; and
based on adjusting the tilt angle, transmitting a frequency band to at least a portion of the network coverage area associated with the network outage of the neighboring cell site.

2. The system according to claim 1, wherein the network coverage area corresponds to a sector of a plurality of sectors in which the neighboring cell site provides telecommunication services.

3. The system according to claim 1, wherein determining that the neighboring cell site has the network outage is based on receiving an indication over an X2 interface that the neighboring cell site has the network outage.

4. The system according to claim 1, wherein the tilt angle is adjusted by applying an up tilt.

5. The system according to claim 1, the operations further comprising:
determining that the neighboring cell site no longer has the network outage; and
based on the neighboring cell site no longer having the network outage, readjusting the tilt angle of the at least one antenna by applying a down tilt.

6. The system according to claim 1, wherein determining that the neighboring cell site has the network outage is based on receiving an indication over an Xn interface that the neighboring cell site has the network outage.

7. The system according to claim 1, wherein determining that the neighboring cell site has the network outage is based on receiving an indication over a backhaul that the neighboring cell site has the network outage.

8. The system according to claim 1, wherein the neighboring cell site is determined as having the network outage based on a generated list of neighboring cell sites.

9. The system according to claim 1, wherein the network coverage area associated with the network outage is identified based on retrieving parameters of the network coverage area from a database.

10. A method for network outage coverage optimization, the method comprising:
receiving an indication that a neighboring cell site has a network outage;
determining parameters of a network coverage area associated with the network outage;
based on the parameters of the network coverage area, adjusting a tilt angle of at least one antenna; and
based on adjusting the tilt angle, transmitting a frequency band to at least a portion of the network coverage area associated with the network outage of the neighboring cell site.

11. The method according to claim 10, further comprising adjusting a tilt angle of an antenna array comprising the at least one antenna, and transmitting frequency bands including the frequency band to at least the portion of the network coverage area.

12. The method according to claim 10, further comprising determining the parameters of the network coverage area based on the parameters being included within the indication.

13. The method according to claim 10, wherein the indication is received over an X2 interface.

14. The method according to claim 10, wherein the tilt angle of the at least one antenna is adjusted by applying an up tilt, the method further comprising:
receiving a second indication that the neighboring cell site no longer has the network outage; and
based on the neighboring cell site no longer having the network outage, readjusting the tilt angle of the at least one antenna by applying a down tilt.

15. One or more computer storage media having computer-executable instructions embodied thereon, that when executed by at least one processor, cause the at least one processor to perform a method comprising:
determining that a neighboring access point, of a first access point, has a network outage;
based on determining that the neighboring access point has the network outage, causing a tilt angle of at least one antenna of the first access point to be adjusted; and
based on causing the tilt angle to be adjusted, causing a frequency band from the first access point to be transmitted to at least a portion of a network coverage area associated with the network outage of the neighboring access point.

16. The one or more computer storage media of claim 15, wherein the tilt angle is caused to be adjusted based on identifying parameters of the network coverage area associated with the network outage.

17. The one or more computer storage media of claim 15, wherein the neighboring access point is a gNodeB and the first access point is an eNodeB.

18. The one or more computer storage media of claim 15, wherein determining that the neighboring access point has the network outage is based on the first access point receiving an indication over an Xn interface that the neighboring access point has the network outage.

19. The one or more computer storage media of claim 15, wherein determining that the neighboring access point has the network outage is based on the first access point receiving an indication over a backhaul that the neighboring access point has the network outage.

20. The one or more computer storage media of claim 15, the method comprising causing the tilt angle to be adjusted by an up tilt, the method further comprising:
receiving an indication that the neighboring access point no longer has the network outage; and
based on the neighboring access point no longer having the network outage, causing the tilt angle to be readjusted by a down tilt.
